(19) United States
(12) Patent Application Publication
(10) Pub. No.: US 2001/0039311 A1
(43) Pub. Date: Nov. 8, 2001

(54) Polysiloxane-containing copolymer and flame-retardant resin composition using the same

(75) Inventors: Makoto Soyama, Tokyo (JP); Masatoshi Iji, Tokyo (JP); Shin Serizawa, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/816,914

(22) Filed: Mar. 23, 2001

(30) Foreign Application Priority Data
Mar. 24, 2000 (JP) 2000-084484

(51) Int. Cl. C08F 8/00

(52) U.S. Cl. 525/100

(57) ABSTRACT

The present invention provides a polysiloxane-containing copolymer obtained by copolymerization of a silicone compound having a basic backbone shown by the general formula (I):

(R¹₃SiO_{0.5})ₐ(R²₂SiO)_{b}(R³SiO_{1.5})_{c}(SiO₂)_{d} (I)

wherein, R¹, R² and R³ are each an aromatic residue or hydrocarbon group having a carbon atom number of 1 to 6, which may be the same or different; and “a”, “b”, “c” and “d” satisfy a relationship (a+b+c+d)=1, and an aromatic residue with a polycarbnate-based resin,

wherein the aromatic residue accounts for 30 to 95%, and a relationship 0<c+d holds in the general formula (I).

### BACKGROUND OF THE INVENTION

1. Field of the invention

The present invention relates to a polysiloxane-containing copolymer, more particularly a polysiloxane-containing copolymer which imparts high degree of flame-retardancy to thermoplastic resin widely used in various areas, e.g., electric and electronic members, machine members, and automobile members.

2. Description of the related Art

Thermoplastic resins have found various applicable areas, because of their excellent formability, and mechanical and electrical properties. In particular, styrene-based resins, e.g., high-impact polystyrene (HIPS) and acrylonitrile-butadiene-styrene (ABS) resins are massively going into various areas, e.g., housings for home electronic and OA devices, interior and exterior decoratives, building materials, and automobile members, because of their low cost in addition to their excellent characteristics.

However, these thermoplastic resins are generally easily combustible, and may cause hazards to human safety when the organic component thereof burns, and hence they are required to be flame-retardant. A variety of standards, e.g., UL standard, are becoming increasingly stringent, and it has been mandated to make thermoplastic resins flame-retardant. Therefore, the thermoplastic resins for electric/electronic and OA devices are required to satisfy higher flame-retardancy, equivalent to the UL 94V-0 and 94-V1 standards, to meet the safety-related requirements.

The common measures to improve flame-retardancy are to compound a halogen (e.g., bromine) compound with high efficiency in importing fine-retardancy as a flame-retardant and an antimony compound as a flame-retardant aid to resins. These measures, however, involve several problems, e.g., large quantities of smoke are produced, and toxic gases containing the halogen are given off, when they burn. A phosphorus compound, e.g., red phosphorus or phosphate ester, may be used as the flame-retardant. However, safety of the phosphorus-based flame-retardant is not sufficiently established, and the resin containing this agent is less resistant to moisture and heat.

Use of an organopolysiloxane-polycarbonate-based resin copolymer is another measure for improving flame-retardancy which depends neither on halogen nor on phosphorus. A polycarbonate-based resin is generally more flame-retardant than other thermoplastic resins, and can be further improved in this property when copolymerized with an organopolysiloxane.

Japanese Patent Laid-Open No. 8-81620 discloses a polydimethylsiloxane-polycarbonate copolymer, describing that the polycarbonate resin incorporated with this copolymer shows improved flame-retardancy.

Japanese Patent Laid-Open No. 8-176427 discloses an organopolysiloxane-polycarbonate copolymer of specific structure and relatively low molecular weight (e.g., 1000 or so), describing that the thermoplastic resin shows improved flame-retardancy when incorporated with this copolymer.

Various compositions composed of the polycarbonate-organopolysiloxane copolymer combined with a variety of flame-retardants have also been investigated, as disclosed by, e.g., Japanese Patent Laid-Open Nos. 1-210462, 4-202465 and 11-152398.

### SUMMARY OF THE INVENTION

However, it is difficult for the above polycarbonate-organopolysiloxane copolymer to realize high flame-retardancy which is now in demand.

It is also difficult for the conventional polycarbonate-organopolysiloxane copolymer to impart sufficient flame-retardancy to a system, e.g., polystyrene-based resin, incorporated with a flame retardant. A polycarbonate resin, being expensive and not highly formable, is frequently combined with another resin less expensive and more formable, e.g., polystyrene-based resin. It is, however, difficult for such a composite resin to show improved flame-retardancy, because the less flame-retardant component, e.g., polystyrene-based resin, tends to separate out in the surface area.

The inventors of the present invention have found, after having extensively studied various procedures to impart flame-retardancy to the above systems, that it is important (1) to segregate a more flame-retardant component in the surface area of the formed article, and (2) to uniformly distribute the more flame-retardant component in the surface area of the formed article, in order to impart high flame-retardancy to the article.

The conventional polycarbonate-organopolysiloxane copolymer is rarely designed while taking into account the morphology of the copolymer present in the article, and still less designed to secure uniform distribution of the organopolysiloxane component in the surface area of the formed article.

The present invention, which has been developed to solve the above problems, provides a polysiloxane containing copolymer showing unprecedentedly high flame-retardancy. In particular, it imparts unprecedentedly high flame-retardancy to a composite of a resin low in cost and high in formability, e.g., polystyrene-based resin, and flame-retardant resin, e.g., polycarbonate-based resin.

The present invention provides,

a polysiloxane-containing copolymer obtained by copolymerizing of a silicone compound and a polycarbnate-based resin,

said silicone compound having an aromatic residue and an organopolysiloxane shown by the general formula (I) as a basic backbone:

(R¹₃SiO_{0.5})ₐ(R²₂SiO)_{b}(R³SiO_{1.5})_{c}(SiO₂)_{d} (I)

wherein R¹, R² and R³ are each an aromatic residue or hydrocarbon group having a carbon atom number of 1 to 6, which may be the same or different; and “a”, “b”, “c” and “d” satisfy a relationship (a+b+c+d)=l, and said aromatic residue accounts for 30 to 95% of the total functional groups said silicone compound has, and a relationship 0<c+d holds in the general formula (I).

It is preferable that a relationship 0.2<c+d <0.95 holds in the general formula (I), more preferably a relationship 0.5<c+d<0.95 holds.

It is also preferable that the silicone compound has a weight-average molecular weight of 300 to 100,000.

It is still preferable that the copolymer is obtained by copolymerization of 0.5 to 80% by weight of the silicone compound and 20 to 99.5% by weight of the polycarbonate-based resin.

The present invention also provides, a polysiloxane-containing copolymer obtained by copolymerizing of a silicone compound and a liquid-crystal polyester,

said silicone compound having an aromatic residue and an organopolysiloxane shown by the general formula (I) as a basic backbone:

(R¹₃SiO_{0.5})ₐ(R²₂SiO)_{b}(R³SiO_{1.5})_{c}(SiO₂)_{d} (I)

wherein R¹, R² and R³ are each an aromatic residue or hydrocarbon group having a carbon atom number of 1 to 6, which may be the same or different; and “a”, “b”, “c” and “d” satisfy a relationship (a+b+c+d)=1 and c+d>0.

The present invention also provides,

a polysiloxane-containing copolymer obtained by copolymerizing of a silicone compound and a polystyrene based resin,

said silicone compound having an aromatic residue and an organopolysiloxane shown by the general formula (I) as a basic backbone:

(R¹₃SiO_{0.5})ₐ(R²₂SiO)_{b}(R³SiO_{1.5})_{c}(SiO₂)_{d} (I)

wherein R¹, R² and R³ are each an aromatic residue or hydrocarbon group having a carbon atom number of 1 to 6, which may be the same or different; and “a”, “b”, “c” and “d” satisfy a relationship (a+b+c+d)=1 and c+d>0.

The present invention also provides,

polysiloxane-containing copolymer comprising:

structural unit (A) derived from a silicone compound having an organopolysiloxane shown by the general formula (I) as a basic backbone:

(R¹₃SiO_{0.5})ₐ(R²₂SiO)_{b}(R³SiO_{1.5})_{c}(SiO₂)_{d} (I)

wherein, R¹, R² and R³ are each an aromatic residue or hydrocarbon group having a carbon atom number of 1 to 6, which may be the same or different; and “a”, “b”, “c” and “d” satisfy a relationship (a+b+c+d)=1, and an aromatic residue; and

structural unit (B) containing an aromatic residue in a main chain backbone or side chain,

wherein said aromatic residue accounts for 30 to 95% of the total functional groups said silicone compound has, and the relationship 0<c+d holds in the general formula (1).

The examples of the structural unit (B) include repeating units such as polystyrene, acrylonitrile-styrene, and polycarbonate units, and liquid-crystal polyester units.

The present invention also provides a flame-retardant resin composition comprising 0.5 to 80% by weight of one of the above-mentioned polysiloxane-containing copolymers, and 20 to 99.5% by weight of one or more resins selected from the group consisting of polycarbonate-based resins, liquid-crystal polyesters and polystyrene-based resins.

The polysiloxane-containing copolymer of the present invention segregates to a high extent in the surface area of the formed article, when combined with another type of resin to form a resinous forming material and injection-molded. This distributes the highly flame-retardant copolymer component to the external surface of the formed article at a high concentration, making the article difficult to ignite and highly flame-retardant.

The polysiloxane-containing copolymer of the present invention, having the above-described specific structure, (1) segregates in the surface area of the formed article to a high extent, and (2) is uniformly distributed in the surface area of the formed article. Therefore, the copolymer of the present invention, when incorporated in a composite system composed of a resin of low flame-retardancy, e.g., polystyrene-based resin, and polycarbonate-based resin, makes the composite sufficiently flame-retard.

The polysiloxane-containing copolymer of the present invention is highly recyclable, which is its another advantage. When mixed with another resin and injection molded, it segregates in the surface area of the formed article, after the phase-separation takes place in the composition. The phase-separation is attributable to the properties of the copolymer components. When the formed article is recycled and formed again, it allows the copolymer to segregate in the surface area of the formed article, as it does in the first time, unlike the layered structure which is formed by timed injection-molding of different resins separately. Therefore, the recycled article containing the copolymer of the present invention is similarly flame-retardant.

### BRIEF DESCRIPTION OF THE DRAWINGS

FIG. 1 illustrates the relationship between the copolymer prepared by each Example and type of the stock silicone compound.

FIG. 2 illustrates the relationship between the copolymer prepared by each Example and type of the stock silicone compound.

### DETAILED DESCRIPTION OF THE PREFFERED EMBODYMENTS

The copolymer of the present invention is obtained by copolymerizing a silicone compound with a thermoplastic resin, where the reactive functional group in the silicone compound reacts with that in the thermoplastic resin to form the copolymer. The copolymer of the present invention decreases in melting viscosity and surface tension, on account of the structural unit derived from the silicone compound, and notably separates out in the surface area of the formed article. The structural unit derived from the silicone compound in the copolymer is highly flame-retardant, and segregates in surface area of the article, making the article unprecedentedly highly flame-retardant.

The copolymer of the present invention uniformly distributes silicone in the surface area of the formed article, which also contributes to much improved flame-retardancy of the article. Taking as an example a formed article coated with the outer layer of polydimethyl siloxane and a thermoplastic resin, the polydimethyl A siloxane may be unevenly distributed in the surface area to make the article insufficiently flame-retardant. By contrast, the copolymer containing the silicone component (organopolysiloxane unit) has a very even distribution of the silicone in the surface area of the article, because these units come together to effectively prevent the uneven distribution. The article surface area has a particularly even distribution of silicone, when the silicone compound has an aromatic residue and the thermoplastic resin has an aromatic ring, e.g., polycarbonate-based resin, liquid-crystal polyester and polystyrene-based resin.

The thermoplastic resin for the copolymer of the present invention preferably has an aromatic ring in the main chain backbone, but the one having the aromatic residue in the side chain is acceptable. The resin of such a structure improves resistance of the copolymer to heat. More concretely, the thermoplastic resins useful for the present invention include polycarbonate, liquid-crystal polyester, polystyrene, acrylonitrile-styrene resin, polyphenylene sulfide, polysulfone, polyether sulfone, polyetheretherketone, polyimide, polyamideimide, polyetherimide, poly-p-phenyleneterephthalamide, polybutylene terephthalate, and their derivatives. Of these, polycarbonate, liquid-crystal polyester, polystyrene and their derivatives are more preferable, because of their good flame-retardancy and formability. They may be used either individually or in combination.

The polycarbonate-based resin for the present invention has the polycarbonate unit shown by the following general formula and a functional group reactive with the silicone compound. Such a reactive functional group is located, e.g., at the terminal of the polycarbonate-based resin.

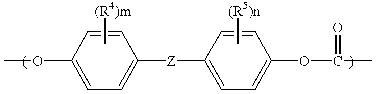

wherein, R⁴ and R⁵ are each an alkyl group having a carbon atom number of 1 to 6 or aryl group having a carbon atom number of 6 to 12, which may be the same or different; “m” and “n” are each an integer of 0 to 4; and Z is a single bond, alkylene or alkylidene having a carbon atom number of 1 to 6, cycloalkylene, cycloalkylidene or fluolenylidene having a carbon atom number of 5 to 20, or —O—, —S—, —SO—, —SO₂— or —CO— bond.

The polycarbonate-based resin is a polymer obtained by the phosgene method in which a varying type of dihydroxydiaryl compound is reacted with phosgene, or ester-exchanging method in which a dihydroxydiaryl compound is reacted with a carbonate ester, e.g., dihenyl carbonate. A representative one is a polycarbonate resin derivative produced from 2,2-bis(4-hydroxyphenyl)propane(bisphenol A) as the dihydroxydiaryl compound.

The dihydroxydiaryl compounds useful for the present invention include, in addition to bisphenol A, bis(hydroxyaryl)alkanes, e.g., bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, 1,1-bis(4-hydroxy-3-tertiary butylphenyl)propane, 2,2-bis(4-hydroxy-3-bromophenyl)propane, 2,2-bis(4-hydroxy-3,5-dibromophenyl)propane, and 2,2-bis(4-hydroxy-3,5-dichlorophenyl)propane; bis(hydroxyaryl)cycloalkanes, e.g., 1,1-bis(4-hydroxyphenyl)cyclopentane and 1,1-bis(4-hydroxyphenyl)cyclohexane; dihydroxydiaryl ethers, e.g., 4,4′- dihydroxydiphenyl ether, 4,4′-dihydroxy-3,3′-dimethyldiphenyl ether; dihydroxydiaryl sulfides, e.g., 4,4′-dihydroxydiphenyl sulfide; dihydroxydiaryl sulfoxides, e.g., 4,4′-dihydroxydiphenyl sulfoxide, 4,4′-dihydroxy-3,3′-dimethyldiphenyl sulfoxide; and dihydroxydiaryl sulfones, e.g., 4,4′-dihydroxydiphenyl sulfone, 4,4′-dihydroxy-3,3′-dimethyldiphenyl sulfone.

They may be used either individually or in combination. However, they are preferably free of a halogen substituent, in environmental consideration of causing no air pollution with the halogen-containing gas produced when they burn. In addition, piperazine, dipiperizyl hydroquinone, resorcin, 4,4′-dihydroxydiphenyl or the like may be incorporated.

Moreover, the dihydroxyaryl compound may be mixed with a trivalent or higher phenolic compound, described below.

The trivalent or higher phenolic compounds useful for the present invention include fluoroglycin, 4,6-dimethyl-2,4,6-tri-(4-hydroxyphenyl)-heptane, 2,4,6-dimethyl-2,4,6-tri-(4-hydroxyphenyl)-heptane, 1,3,5tri-(4-hydroxyphenyl)benzole, 1,1,1-tri-(4-hydroxyphenyl)-ethane, and 2,2-bis-[4,4-(4,4′-dihydroxydiphenyl)-cyclohexyl]-propane.

The polycarbonate-based resin has generally a viscosity-average molecular weight of 10,000 to 100,000, preferably 15,000 to 35,000. It can be produced in the presence of, e.g., a molecular weight adjusting agent or catalyst, as necessary.

The liquid-crystal polyester for the present invention is a polyester referred to as a thermotropic liquid-crystal polymer and has a functional group reactive with a silicone compound. The reactive functional group is located, e.g., at the terminal of the polycarbonate resin. More concretely, these esters include (1) a combination of aromatic dicarboxylic acid, aromatic diol and aromatic hydroxycarboxylic acid, (2) a combination of different types of aromatic hydroxycarboxylic acids, (3) a combination of aromatic dicarboxylic acid and nucleus-substituted aromatic diol, and (4) a product of the reaction between a polyester, e.g., polyethylene terephthalate, and aromatic hydroxycarboxylic acid. Each can form an anisotropic melt at 400° C. or lower. The aromatic dicarboxylic acid, aromatic diol or aromatic hydroxycarboxylic acid may be replaced by its derivative capable of forming the ester. The examples of the repeating structural unit for the liquid-crystal polyester are described below. Temperature at which the liquid-crystal polyester becomes fluid is normally defined as the level at which it has a melting viscosity of 48,000 poise when it is extruded from a nozzle, 1 mm in inside diameter and 10 mm in length, while being heated at 4° C./minute at a load of 100 kgf/cm².

The repeating structural unit derived from the aromatic dicarboxylic acid:

X: a halogen, alkyl or aryl group

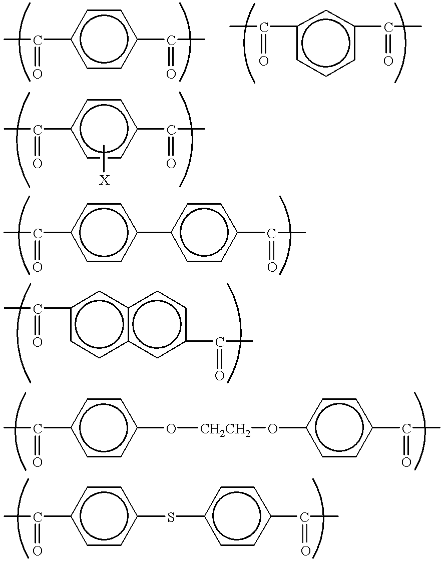

X: a halogen, alkyl or aryl group

X is halogen, alkyl or aryl. The repeating structural unit derived from the aromatic diol:

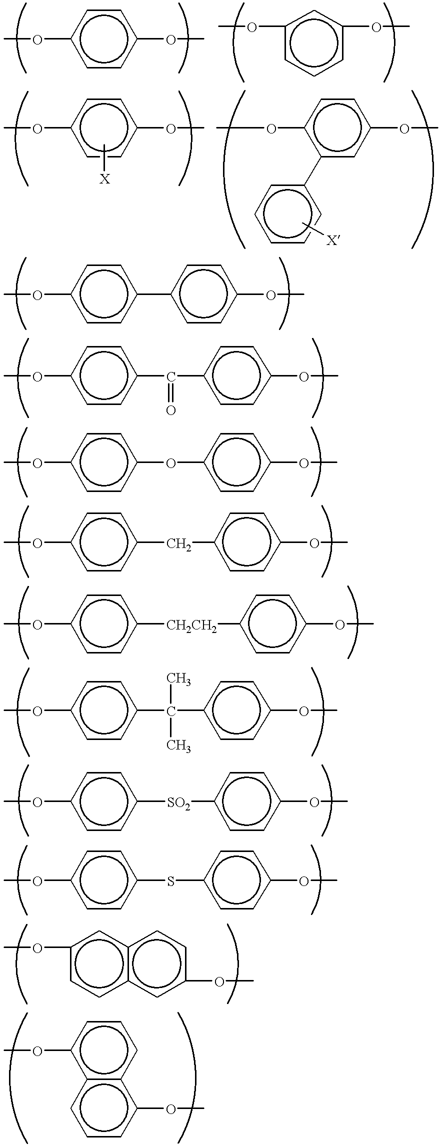

X: a halogen, alkyl or aryl group

X′: a halogen or alkyl group

The repeating structural unit derived from the aromatic hydroxycarboxylic acid:

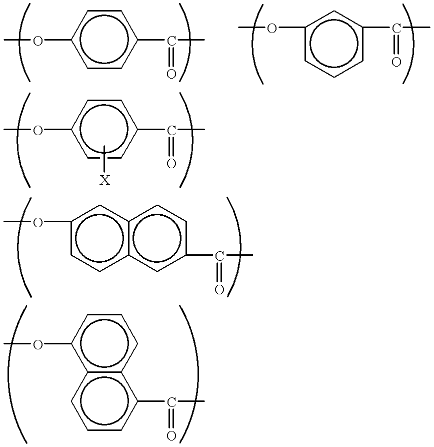

X: a halogen, alkyl or aryl group

The particularly preferable liquid-crystal polyesters, viewed from balanced properties of resistance to heat, mechanical properties, processability and flame-retardancy, are those containing at least 30 mol % of the repeating structural unit shown by the formula:

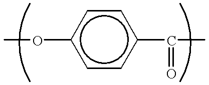

More concretely, the preferable repeating structural units are represented by the following combinations (I) to (VI):

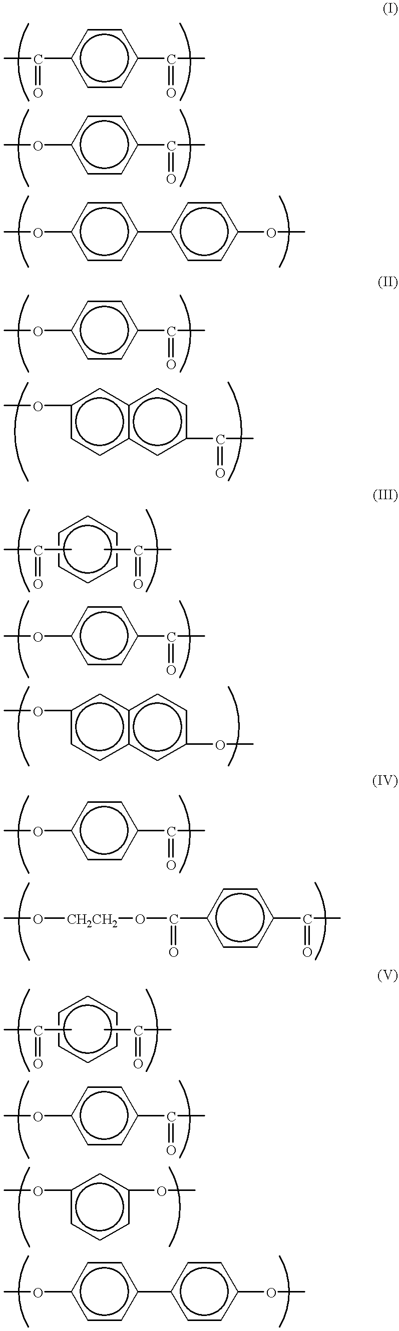

These liquid-crystal polyesters (I) to (VI) may be produced by the methods disclosed by, e.g., Japanese Patent Publication Nos. 47-47870, 63-3888, 63-3891, 56-18016 and 2-51523. Of these, the preferable combination is (I), (II) and (IV), more preferably (I) and (II).

The polystyrene-based resin is a synthetic resin, obtained by polymerization of styrene, adequately incorporated with one or more components, and having the functional group reactive with a silicone compound. The reactive functional group is located, e.g., at the terminal of the polycarbonate-based resin.

The polystyrene-based resin useful for the present invention include those incorporated or copolymerized with a rubber component, in order to have improved resistance to impact. The rubber component, although not limited, is normally of butadiene. The polystyrene in the rubber-reinforced polystyrene-based resin may be partly replaced with another aromatic vinyl compound. These aromatic vinyl compounds include α-methyl styrene, p-methyl styrene, p-hydroxystyrene, vinyl toluene, and sodium styrene sulfonate. A copolymer or graft polymer with another monomer, e.g., acrylonitrile, may be incorporated in order to improve resin properties.

More concretely, the examples of the rubber component include impact-resistant polystyrene, i.e., rubber-reinforced polystyrene (HIPS), acrylonitrile butadiene-styrene (ABS) copolymer resin, and styrene-butadiene rubber (SBR). The polystyrene-based resin and rubber-reinforced polystyrene-based resin may be produced by the known method, e.g., self-polymerization, solution polymerization or suspension polymerization, or by blending with a molten resin.

Next, the silicone compound for the present invention will be described. The silicone compound for the present invention has an organopolysiloxane backbone shown by the general formula (I):

(R¹₃SiO_{0.5})ₐ(R²₂SiO)_{b}(R³SiO_{1.5})_{c}(SiO₂)_{d} (I)

wherein, R¹, R² and R³ are each an aromatic residue or hydrocarbon group having a carbon atom number of 1 to 6, which may be the same or different; and “a”, “b”, “c” and “d” satisfy relationships (a+b+c+d)=1 and c+d>0, and has a functional group reactive with a thermoplastic resin with which the silicone compound is copolymerized for the present invention. Such a reactive functional group is located, e.g., at the terminal of the polycarbonate-based resin.

The silicone compound useful for the present invention preferably contains T unit represented by (R³Si_{1.5}) and Q unit represented by (SiO₂) at a certain content or more. More concretely, it is preferable to keep the branched unit content α , shown by the following formula:

α=(c+d)

at a certain level or more. At an excessively low α level, the silicone compound may have insufficient resistance to heat, possibly making the resin composition insufficiently flame-retardant.

The copolymer of the organopolysiloxane and polycarbonate-based resin preferably has an a level more than 0.2, more preferably more than 0.5, still more preferably more than 0.6.

The copolymer of the organopolysiloxane and liquid-crystal polyester preferably has an a level of 0.1 or more, more preferably of 0.2 or more. The liquid-crystal polyester itself is high in heat resistance, and makes the copolymer sufficiently flame-retardant at a lower a level than the polycarbonate-based resin.

The copolymer of the organopolysiloxane and polystyrene-based resin preferably has an a level of 0.1 or more, more preferably of 0.2 or more. The copolymer with the polystyrene-based resin is highly formable, and can make a good forming material by itself or when incorporated with a small quantity of another resin. As a result, the polystyrene-based resin allows to set the copolymer content at a high level in the whole forming material, and makes the copolymer sufficiently flame-retardant at a lower ax level than the polycarbonate-based resin.

It is preferable to keep the upper limit of the a level at 0.95 or less for each of the above copolymers. At an a level above 0.95, degree of freedom of the silicone's main chain decreases, preventing condensation of the aromatic residue during the combustion process, and may conversely deteriorate the flame-retardancy.

The silicone compound for the present invention preferably contains the aromatic residue at a certain content or more, based on all of the organic functional groups in the compound. This is to accelerate condensation of the aromatic residue during the combustion process, greatly improve dispersion of the silicone compound in the thermoplastic resin, and produce the very high flame-retardant effect. At an excessively low aromatic residue content, condensation of the residue with each other will be prevented during the combustion process, possibly deteriorating the flame-retardant effect. The organic functional group present in the silicone compound is the one bonded to the main chain or branched side chain.

The aromatic residue in the silicone compound is the functional one derived from an aromatic compound. The aromatic compound is the compound having an aromatic ring, such as benzene ring, condensed benzene ring, polyaromatic ring, non-benzene aromatic ring or heteroaromatic ring. These compounds include benzene, naphthalene, anthracene, and others, e.g., biphenyl, diphenyl ether, biphenylene, pyrrole and their derivatives. The derivatives include those in which an alkyl group having a carbon atom number of 1 to 10 is added to the above described compounds. One of the preferable aromatic residua is phenyl group, because of its excellent effect of improving flame retardancy.

The preferable aromatic residue content will be described below concretely for each type of the copolymer.

In the copolymer of the organopolysiloxane and polycarbonate-based resin, the aromatic residue content is preferably 30% or more, more preferably 40% or more.

In the copolymer of the organopolysiloxane and liquid-crystal polyester, the aromatic residue content is preferably 10% or more, more preferably 30% or more. The liquid-crystal polyester itself is high in heat resistance, and makes the copolymer sufficiently flame-retardant at a lower aromatic residue content than the polycarbonate-based resin.

In the copolymer of the organopolysiloxane and polystyrene-based resin, the aromatic residue content is preferably 10% or more, more preferably 30% or more. The copolymer with the polystyrene-based resin is highly formable, and can make a good forming material by itself or when incorporated with a small quantity of another resin. As a result, the polystyrene-based resin allows to set the copolymer content at a high level in the whole forming material, and makes the copolymer sufficiently flame-retardant at a lower aromatic residue content than the polycarbonate-based resin.

It is preferable to keep the upper limit of the aromatic residue content at 95 mol % or less for each of the above copolymers. The aromatic residue, when present at above 95 mol %, may cause the steric hindrance with each other, possibly preventing its condensation and making it difficult to attain a desired level of the flame-retardant effect.

The organic functional group other than the aromatic residue is not limited, but it is preferable that methyl group accounts for the majority of the remaining groups, because it can improve dispersion of the silicone compound in the thermoplastic resin.

Methyl, phenyl or hydroxyl group may serve as the terminal group for the silicone compound. The group reactive with the other resin with which the silicon compound is copolymerized is adequately introduced.

The copolymer of the present invention is composed of the silicone compound copolymerized with the other resin. It is preferable to keep extent of copolymerization of the silicone compound in a specific range. At an excessively low extent of copolymerization, sufficiently high flame-retardancy may not be secured for the copolymer. On the other hand, excessively increasing extent of copolymerization may cause other problems, e.g., deteriorated formability of the copolymer and increased cost of the resin material.

In the copolymer of the organopolysiloxane and polycarbonate-based resin, it is preferable to copolymerize 0.5 to 80% by weight of the silicone compound with 20 to 99.5% by weight of the polycarbonate-based resin.

In the copolymer of the organopolysiloxane and liquid-crystal polyester, it is preferable to copolymerize 0.5 to 80% by weight of the silicone compound with 20 to 99.5% by weight of the liquid-crystal polyester.

In the copolymer of the organopolysiloxane and polystyrene-based resin, it is preferable to copolymerize 0.5 to 80% by weight of the silicone compound with 20 to 99.5% by weight of the polystyrene-based resin.

The silicone compound for the present invention preferably has a weight-average molecular weight of 300 or more, more preferably 500 or more, still more preferably 1,000 or more. At an excessively low molecular weight, sufficiently high flame-retardancy may not be secured for the copolymer. The upper limit of the molecular weight is preferably 100,000 or less. It is preferable to select an adequate molecular weight for the silicone compound, depending on that of the thermoplastic resin with which it is copolymerized.

The copolymer of the present invention can be obtained by copolymerizing the silicone compound having a reactive functional group (a) with the thermoplastic resin having a reactive functional group (b) which is reactive with the group (a). It can be also obtained by radical-polymerization of the silicone compound, to which a radical-polymerizable functional group is introduced, with a radical polymerizable monomer which can react with the above functional group in the presence of a polymerization initiator.

The reactive functional group may be freely selected from the group consisting of, e.g., hydroxyl, epoxy, amino, hydroxyl, carboxyl, acyl, mercapto, methacrylo, isocyanate, ureide, vinyl, amide, imide, imino, aldehyde, nitro, nitrile, oxime, azo, hydrazone, alkoxy, alkoxysilyl, and thiol. In the production of the copolymer of the silicone compound and thermoplastic resin for the present invention, it is preferable to select the reactive group for the silicone compound depending on the thermoplastic resin with which it is copolymerized, and thereby to effectively copolymerize them.

The preferable combinations of the groups (a) and (b) are epoxy group and amino, hydroxyl, carboxyl, mercapto, amino, hydroxyl, carboxyl, vinyl, amide, imide or imino group, and hydroxyl group and alkoxy or mercapto group.

The radical-polymerizable monomers useful for the present invention include acrylate and methacrylate ester derivatives, e.g., phenyl (meth)acrylate and benzyl (meth)acrylate; styrene and its derivatives, e.g., styrene, a methyl styrene and p-tert-butyl styrene; and vinyl toluene, acrylonitrile, vinyl acetate, vinyl propionate and vinyl versatate.

The polymer with a reactive group at the terminal may be obtained by polymerizing a radical-polymerizable monomer in the presence of a radical-polymerization initiator or chain transfer agent having the reactive group. The radical-polymerization initiators having carboxyl group in the molecule include, e.g., 4,4′-azobis(4-cyanovaleric acid), and commercially available (VA-548, VA-558, VA-059, VA-060, VA-080, VA-082, VA-086, VA-077, V-501 and VF-077, all trade names of Wako Pure Chemicals Industries, Ltd.). They may be used either individually or in combination, for production of the polymer having carboxyl group at the terminal.

The radical-polymerization initiators having hydroxyl group in the molecule include 2,2′-azobis[N-(4-hydroxyphenyl)-2-methylpropioneamidine]dihydrochloride, 2,2′-azobis[N-(2-hydroxyethyl)-2-methylpropioneamidine]dihydrochloride, and 2,2′-azobis[2-(5-hydroxy-3,4,5,6-tetrahydropyridin-2-yl)propane]dihydrochloride. They may be used either individually or in combination, for production of the polymer having hydroxyl group at the terminal.

The polymer having carboxyl or hydroxyl group at one terminal can be reacted with a compound having both a functional group reactive with the above functional groups and a radical-polymerizable unsaturated group to introduce the radical-polymerizable unsaturated group at that terminal. In the case of the polymer having carboxyl group at one terminal, the unsaturated compounds having a functional group reactive with the above polymer include radical-polymerizable unsaturated monomers, e.g., glycidyl (meth)acrylate, 3,4-epoxycyclohexylmethyl (meth)acrylate and 2-methylglycidyl (meth)acrylate. The polymer having the radical-polymerizable unsaturated group at one terminal can be obtained by reacting the radical-polymerizable unsaturated monomer with 1 to 5 mols of the carboxyl group in the above polymer per mol of the monomer.

In the case of the polymer having hydroxyl group at one terminal, the unsaturated compounds having a functional group reactive with the above polymer include acid chloride compounds, e.g., (meth)acrylic acid chloride; compounds having both isocyanate and an unsaturated groups, e.g., products of a diisocyanate compound reacting with equimolar 2-hydroxyethyl (meth)acrylate, isocyanate ethyl (meth)acrylate, isocyanate propyl (meth)acrylate, isocyanate butyl (meth)acrylate, isocyanate hexyl (meth)acrylate, m-isopropenyl-α ,α′-dimethylbenzylisocyanate, and m-ethylenyl-α , α ′-dimethylbenzylisocyanate; acid anhydrous-based compounds, e.g., anhydrous itaconic and maleic acids; and N-methylol (meth)acrylamide and N-n-butoxy (meth)acrylamide. The polymer having the radical polymerizable unsaturated group at one terminal can be obtained by reacting the radical-polymerizable unsaturated monomer with 1 to 5 mols of the hydroxyl group in the above polymer per mol of the monomer. The styrene-based polymer having the radical-polymerizable unsaturated group at one terminal can be used after being purified and separated from the unreacted compounds.

It is also possible to produce the copolymer of the thermoplastic resin and silicone compound by reacting the polymer having the radical-polymerizable unsaturated group at one terminal prepared by the above synthetic method with hydrogenated silane through the hydrosilylation process.

The chain transfer agents useful for the present invention include mercaptan compounds containing carboxyl group, e.g., mercaptoacetic acid, 2-mercaptopropionic acid and 3-mercaptopropionic acid. Production of the polymer having carboxyl group at one terminal of the main chain in the molecule can be accelerated in the presence of the chain transfer agent. The polymer having hydroxyl group at one terminal can be synthesized in the presence of 2-mercaptoethanol as the chain transfer agent of a mercaptan compound containing the functional group, and the polymer having amino group at one terminal of the main chain in the molecule can be synthesized in the presence of 2-aminoethanethiol hydrochlorate as the chain transfer agent.

The flame-retardant thermoplastic resin to be copolymerized with the silicone compound is the one having an aromatic residue in the main chain backbone or side chain. Examples of these copolymers include silicone-polycarbonate, silicone-liquid-crystal polyester, silicone-acrylonitrile-styrene, silicone-polyphenylene sulfide, silicone-polybutylene terephthalate, silicone-polyether sulfone, silicone-polysulfone, silicone-polyetheretherketone, silicone-polyimide, silicone-polyamideimide, silicone-polyetherimide, and silicone-poly-p-phenylene terephthalamide copolymers.

It is preferable, when the resin forming material containing the copolymer of the present invention is designed, to incorporate 0.5 to 150 parts by weight of the copolymer in 100 parts by weight of the resin forming material. At below 0.5 parts by weight, the sufficient flame-retardant effect may not be expected. At above 150 parts by weight, little economic effect will be expected. It is preferably incorporated at 1 to 60 parts by weight, more preferably 3 to 30 parts by weight, inclusive. The resin composition will have more balanced properties of flame-retardancy, formability, impact strength and economic efficiency.

The above forming material may be further incorporated with a metallic salt of aromatic sulfur compound or metallic salt of perfluoroalkane sulfonate.

As the metallic salts of aromatic sulfur compounds, those of aromatic sulfonamides and aromatic sulfonates are employed.

The metallic salts of aromatic sulfonamides useful for the present invention include metallic salts of saccharin, N-(p-tolylsulfonyl)-p-toluenesulfoimide, N-(N′-benzylaminocarbonyl)sulfanilimide, and N-(phenylcarboxyl)-sulfanilimide. The metallic salts of aromatic sulfonates useful for the present invention include those of diphenylsulfone-3-sulfonate, diphenylsulfone-3,3′-disulfonate, and diphenylsulfone-3,4′-disulfonate. They may be used either individually or in combination.

The preferable metals for the salts include Group I metals, e.g., sodium and potassium (alkali metals), Group II metals, and copper and aluminum, of which the alkali metals are more preferable.

Of the above-described metallic salts, the preferable ones include potassium salts of N(p-tolylsulfonyl)-p-toluenesulfoimide, N-(N′-benzylaminocarbonyl)sulfanilimide, and diphenylsulfone-3-sulfonate, of which N-(p-tolylsulfonyl)-p-toluenesulfoimide and N-(N′-benzylaminocarbonyl)sulfanilimide are more preferable.

The metallic salt of aromatic sulfur compound is preferably incorporated at 0.03 to 5 parts by weight, inclusive, per 100 parts by weight of the flame-retardant resin composition. At below 0.03 parts by weight, the notable flame-retardant effect may not be secured. At above 5 parts by weight, on the other hand, thermal stability of the composition may be insufficient during the injection molding process, possibly causing adverse effects on the formability and impact strength. It is more preferably incorporated at 0.05 to 2 parts by weight, still more preferably at 0.06 to 0.4 parts by weight, inclusive. The resin having a such composition will have more balanced properties of flame-retardancy, formability and impact strength.

The preferable metallic salts of perfluoroalkane sulfonates include those of perfluoromethane sulfonate, perfluoroethane sulfonate, perfluoropropane sulfonate, perfluorobutane sulfonate, perfluoromethylbutane sulfonate, perfluorohexane sulfonate, perfluoroheptane sulfonate, and perfluorooctane sulfonate. They may be used either individually or in combination. The metallic salt of perfluoroalkane sulfonate may be used in combination with the above-described metallic salt of aromatic sulfur compound.

The preferable metals for the salts of perfluoroalkane sulfonates include Group I metals, e.g., sodium and potassium (alkali metals), Group II metals, and copper and aluminum, of which the alkali metals are more preferable. Of the metallic salts described above, the most preferable one is the potassium salt of perfluorobutane sulfonate.

The metallic salt of perfluoroalkane sulfonate is preferably incorporated at 0.01 to 5 parts by weight, inclusive, per 100 parts by weight of the flame-retardant resin composition. At below 0.01 parts by weight, the notable flame-retardant effect may not be secured. At above 5 parts by weight, on the other hand, thermal stability of the composition may be insufficient during the injection molding process, possibly causing adverse effects on the formability and impact strength. It is more preferably incorporated at 0.02 to 2 parts by weight, still more preferably at 0.03 to 0.2 parts by weight, inclusive. The resin having a such composition will have more balanced properties of flame-retardancy, formability and impact strength.

The above flame-retardant resin composition can have still improved flame-retardancy, when incorporated with a fiber-forming type fluorine-containing polymer, which is considered to have a drip-preventing effect. Such a fluorine-containing polymer is preferably the one which forms a fibrous stricture (fibril structure) in the thermoplastic resin. Some of the examples of these polymers include polytetrafluoroethylene- and tetrafluoroethylene-based copolymers, e.g., tetrafluoroethylene-hexafluoropropylene copolymer.

The fiber-forming type fluorine-containing polymer is preferably incorporated at 0.05 to 5 parts by weight, inclusive, per 100 parts by weight of the flame-retardant resin composition. At below 0.05 parts by weight, the drip-preventing effect may not be sufficiently secured during the combustion process. At above 5 parts by weight, on the other hand, the granulation of the composition may be difficult, possibly preventing the stable production. It is more preferably incorporated at 0.05 to 1 part by weight, still more preferably at 0.1 to 0.5 part by weight, inclusive. The resin having a such composition will have more balanced properties of flame-retardancy, formability and impact strength.

The flame-retardant resin composition of the present invention may be incorporated with one or more additives within limits not harmful to the object of the present invention. These additives include various types of thermal stabilizers, antioxidants, colorants, fluorescent whitening agents, fillers, releasing agents, softening agents, antistatic agents, and impact property improvers. It may be further incorporated with another type of flame-retardant. Use of such a retardant may greatly reduce requirement of the flame-retardant for the present invention.

The thermal stabilizers useful for the present invention include metal hydrogen sulfates, e.g., sodium, potassium and lithium hydrogen sulfates, and metal sulfates, e.g., aluminum sulfate. It is incorporated normally at 0 to 0.5 parts by weight, inclusive, per 100 parts by weight of the flame-retardant resin composition.

The fillers useful for the present invention include glass fibers, glass beads, glass flakes, carbon fibers, talc particles, clay particles, mica, potassium titanate whiskers, wollastonite particles, and silica particles.

The additives useful for the present invention for improving impact properties include acrylic-based elastomer, polyester-based elastomer, core-shell type methyl methacrylate-butadiene-styrene copolymer, methyl methacrylate-acrylonitrile-styrene copolymer, ethylene propylene-based rubber, and ethylene-propylene-diene-based rubber.

The flame-retardant resin composition of the present invention may be further incorporated with another type of flame-retardant, e.g., phosphorus-based retardant, metal hydroxide, nitrogen compound (e.g., melamine), or halogen-based retardant. Use of such a retardant may greatly reduce the flame-retardant requirement for the present invention.

The method for mixing the flame-retardant resin composition of the present invention with the other components is not limited, and the mixing may be effected by a known mixer, e.g., tumbler or ribbon blender. It may also be molten and kneaded by an extruder.

The method for forming the flame-retardant resin composition of the present invention is not limited. It may be formed by known injection molding or injection/compression molding method, the former being more preferable. Injection molding can cause phase separation more efficiently, and allows the highly flame retardant component to segregate in the outer layer of the formed article, thus greatly enhancing its flame-retardancy.

Table 1 gives some examples (No. 1 to No. 3) of the preferable combinations of the resins which constitute the flame-retardant resin composition of the present invention, where the component (A) may be incorporated with a silicone component (C), metallic salt, or fiber-forming type fluorine-containing polymer, as required.

TABLE 1

| No. | Component A | Component B |
|---|---|---|
| 1 | (1) Polycarbonate-based resin, | Polystyrene-based |
| | and (2) Copolymer of | resin |
| | polycarbonate-based resin and | |
| | silicone compound | |
| 2 | (1) Liquid-crystal polyester | Polystyrene-based |
| | and (2) Copolymer of liquid- | resin |
| | crystal polyester and silicone | |
| | compound | |
| 3 | Copolymer of polystyrene-based | Polystyrene-based |
| | resin and silicone compound | resin |

The copolymer present in the component A for the No. 1 and No. 2 combinations is well compatible with the respective other resin. As a result, the silicone-derived organopolysiloxane unit is uniformly distributed in the outer layer of the formed article, to make the article especially highly flame-retardant.

The copolymer for the No. 3 combination is highly formable, and can singly serve as the component A without being combined with another resin.

### EXAMPLES

The present invention will be described more concretely by Examples, which by no means limit the present invention, where the term “parts” described in Examples and Comparative Examples means parts by weight.

### Example 1

Molecular weight was measured by gel permeation chromatography (GPC) in Examples.

The stock materials used in Examples and Comparative Examples will be described in detail below:

1. Acrylonitrile-styrene resin (AS): AS had a weight-average molecular weight of 80,000.

2. Acrylonitrile-styrene resin with carboxyl group at the terminal (AS-2): AS-2 had a weight-average molecular weight of 80,000. It was prepared by the common method, i.e., by radical-polymerization of acrylonitrile and styrene in the presence of 4,4′-azobis(4-cyanovaleric acid) as the polymerization initiator with carboxyl group.

2. Polycarbonate resin (PC): PC had a weight-average molecular weight of 19,000.

3. Polycarbonate resin with hydroxyl group at the terminal (PC-3): PC-3 had a weight-average molecular weight of 15,600. It was prepared by the common method, i.e., by melt polycondensation of bisphenol-A and diphenyl carbonate. Concentration of the phenolic group at the polycarbonate terminal can be adjusted by changing molar ratio of the aromatic dihydroxy compound to carbonate diester, or reflux condition for the volatile component in the reaction system. For example, decreasing the diester carbonate/aromatic dihydroxy compound molar ratio increases concentration of the phenolic group at the polycarbonate terminal.

4. Silicone compounds (a) and (b): Silicone compounds (a) and (b) were produced by the common method, i.e., an adequate quantity of diorganodichlorosilane, monoorganotrichlorosilane, tetrachlorosilane or partially hydrolyzed/condensate thereof was dissolved in an organic solvent, and hydrolyzed in the presence of water to prepare the partially condensed silicone compound, where quantity of the silane was determined in consideration of molecular weight of the silicone compound component, and ratios of the M, D, T and Q units that constituted the silicone compound. The polymerization process was terminated by adding triorganochlorosilane to the reaction system. Then, the solvent was removed by an adequate method, e.g., distillation. Table 2 gives the structural characteristics of a total of 14 types of the silicone compounds thus prepared.

TABLE 2

| | D/T/Q molar ratio at | | | | |
|---|---|---|---|---|---|
| | the main chain | (T + Q) ratio at the | Molar ratio of | | |
| | backbone, excluding | main chain backbone, | phenyl group in all | | Weight-average |
| Silicone | the terminals where | including the | of the organic | Structure of the terminal group, | molecular |
| compounds | (D + T + Q) is set at one | terminals* | functional groups** | and its molar ratio | weight*** |
| (a) | | | | | |
| a | 0.2/0.8/0 | 0.75 | 60 | Methyl group only | 16,000 |
| b | 0.2/0.8/0 | 0.8 | 60 | Methyl group only | 250,000 |
| c | 1/0/0 | 0 | 0 | Methyl group only | 16,000 |
| (b) | | | | | |
| d | 0.25/0.75/0 | 0.75 | 60 | Methyl group/Si—H group = 8/2 | 450 |
| e | 0.2/0.8/0 | 0.52 | 60 | Methyl group/Si—H group = 8/2 | 700 |
| f | 0.2/0.8/0 | 0.54 | 60 | Methyl group/Si—H group = | 1,600 |
| | | | | 9.5/0.5 | |
| g | 0.2/0.8/0 | 0.63 | 60 | Methyl group/Si—H group = | 5,000 |
| | | | | 9.5/0.5 | |
| h | 0.6/0.4/0 | 0.29 | 60 | Methyl group/Si—H group = | 1,600 |
| | | | | 9.5/0.5 | |
| i | 1/0/0 | 0 | 0 | Methyl group/Si—H group = | 1,600 |
| | | | | 7.5/2.5 | |
| j | 0.6/0.4/0 | 0.35 | 25 | Methyl group/Si—H group = 8/2 | 1,600 |
| k | 0.2/0.8/0 | 0.63 | 60 | Methyl group/hydroxyl group = | 1,200 |
| | | | | 9/1 | |
| l | 0.2/0.8/0 | 0.75 | 60 | Methyl group/hydroxyl group = | 16,000 |
| | | | | 9.5/0.5 | |
| m | 0.2/0.8/0 | 0.8 | 60 | Methyl group/hydroxyl group = | 50,000 |
| | | | | 9.5/0.5 | |
| n | 1/0/0 | 0 | 0 | Methyl group/hydroxyl group = | 16,000 |
| | | | | 9.5/0.5 | |
| *(T + Q) ratio in the main chain backbone including the terminals, i.e., the above-described branched unit content < (= c + d value). | | | | | |
| **Phenyl group is present first in the T unit, when the T unit is present in the silicone compound, and the remainder is present in the D unit. When the phenyl group is bound to the D unit, one phenyl group is preferentially bound to each D unit, and, when there are more phenyl groups remaining, they are bound one by one to the D unit to which one phenyl group has already been bound. Methyl group is the only organic functional group except phenyl | | | | | |
| #group in the silicone molecule except at the terminal. | | | | | |

***Significant figure of the weight-average molecular weight is 2.

5. Copolymers of silicone compound and polycarbonate resin (SiPC-1 to SiPC-7): These copolymers are those prepared by Production Example 2.

6. Copolymers of silicone compound, acrylonitrile and styrene resin (SiAS-1 to SiAS-4): These copolymers are those prepared by Production Example 4.

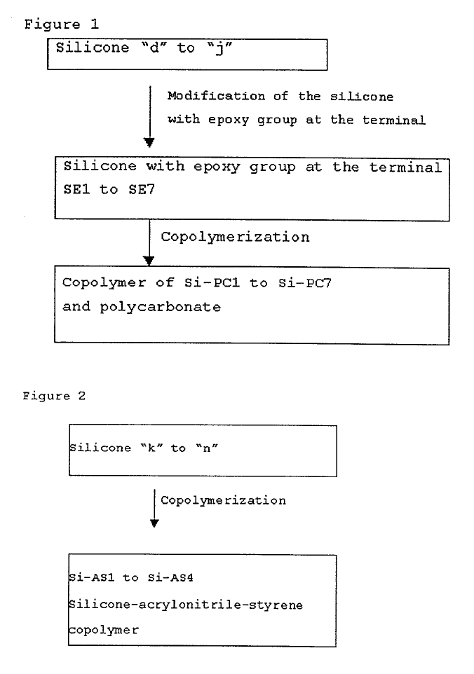

Production Examples for producing the above copolymers used as the stock materials will be described. FIGS. 1 and 2 illustrate the relationships between type of the silicone compound used and copolymer produced.

### Production Example 1: Production of the silicone compound with epoxy group at the terminal

(1) Production of silicone compound with epoxy group at the terminal (SE1)

50 g of 2-allylphenylglycidyl ether was dissolved, under heating and with stirring, in 200 cc of methylisobutylketone as the solvent in a four-mouthed flask having a reflux condenser, thermometer, stirrer and nitrogen inlet nozzle. 0.32 g of a 2% by weight of 2-ethyl hexanol solution of platinic chloride as the catalyst was added to the above solution. Then, the solution was distilled at around 120° C. under reflux of the solvent, to confirm that water was not distilled off for about one hour, the solution was cooled to 100° C., and 56.3 g of the silicone compound “d” (Table 2) was thrown into the reactor in about one hour. The reaction process was continued for 3 hours. Then, the effluent was cooled to room temperature, washed with water 3 times, treated to remove the 2-ethyl hexanol solution of platinic chloride as the catalyst, and treated to distill off the solvent, to prepare 105.8 g of the silicone compound with epoxy group at the terminal (SE1). It was confirmed by the infrared spectral analysis that the Si—H group (absorption wavelength: 2175 cm⁻¹) almost disappeared.

(2) Production of silicone compound with epoxy group at the terminal (SE2)

The silicone compound with epoxy group at the terminal (SE2) was prepared in the same manner as for SE1, except that quantity of methylisobutylketone as the solvent was increased from 200 cc to 250 cc, quantity of the 2% by weight of 2-ethyl hexanol solution of platinic chloride as the catalyst was increased from 0.32 g to 0.42 g, and 56. 3 g of the silicone compound “d” (Table 2) was replaced by 87.5 g of the silicone compound “e”. This produced 137.1 g of SE2. It was confirmed by the infrared spectral analysis that the Si—H group (absorption wavelength: 2175 cm⁻¹) almost disappeared.

(3) Production of silicone compound with epoxy group at the terminal (SE3)

The silicone compound with epoxy group at the terminal (SE3) was prepared in the same manner as for SE1, except that quantity of methylisobutylketone as the solvent was increased from 200 to 400 cc, quantity of the 2% by weight of 2-ethyl hexanol solution of platinic chloride as the catalyst was increased from 0.32 to 0.76 g, and 56.3 g of the silicone compound “d” (Table 2) was replaced by 200 g of the silicone compound “f”. This produced 248.9 g of SE3. It was confirmed by the infrared spectral analysis that the Si—H group (absorption wavelength: 2175 cm⁻¹) almost disappeared.

(4) Production of silicone compound with epoxy group at the terminal (SE4)

The silicone compound with epoxy group at the terminal (SE4) was prepared in the same manner as for SE1, except that quantity of methylisobutylketone as the solvent was increased from 200 to 1200 cc, quantity of the 2% by weight of 2-ethyl hexanol solution of platinic chloride as the catalyst was increased from 0.32 to 2.3 g, and 56.3 g of the silicone compound “d” (Table 2) was replaced by 625 g of the silicone compound “g”. This produced 673.2 g of SE4. It was confirmed by the infrared spectral analysis that the Si—H group (absorption wavelength: 2175 cm⁻¹) almost disappeared.

(5) Production of silicone compound with epoxy group at the terminal (SE5)

The silicone compound with epoxy group at the terminal (SE5) was prepared in the same manner as for SE1, except that quantity of methylisobutylketone as the solvent was increased from 200 to 400 cc, quantity of the 2% by weight of 2-ethyl hexanol solution of platinic chloride as the catalyst was increased from 0.32 to 0.76 g, and 56.3 g of the silicone compound “d” (Table 2) was replaced by 200 g of the silicone compound “h”. This produced 249.2 g of SES. It was confirmed by the infrared spectral analysis that the Si—H group (absorption wavelength: 2175 cm⁻¹) almost disappeared.

(6) Production of silicone compound with epoxy group at the terminal (SE6)

The silicone compound with epoxy group at the terminal (SE6) was prepared in the same manner as for SE1, except that quantity of methylisobutylketone as the solvent was increased from 200 to 400 cc, quantity of the 2% by weight of 2-ethyl hexanol solution of platinic chloride as the catalyst was increased from 0.32 to 0.76 g, and 56.3 g of the silicone compound “d” (Table 2) was replaced by 200 g of the silicone compound “i”. This produced 249.1 g of SE6. It was confirmed by the infrared spectral analysis that the Si—H group (absorption wavelength: 2175 cm⁻¹) almost disappeared.

(7) Production of silicone compound with epoxy group at the terminal (SE7)

The silicone compound with epoxy group at the terminal (SE7) was prepared in the same manner as for SE1, except that quantity of methylisobutylketone as the solvent was increased from 200 to 400 cc, quantity of the 2% by weight of 2-ethyl hexanol solution of platinic chloride as the catalyst was increased from 0.32 to 0.76 g, and 56.3 g of the silicone compound “d” (Table 2) was replaced by 200 g of the silicone compound “j”. This produced 249.3 g of SE6. It was confirmed by the infrared spectral analysis that the Si—H group (absorption wavelength: 2175 cm⁻¹) almost disappeared.

The silicone compounds with epoxy group at the terminal SE1 to SE7 are represented by the following general formula:

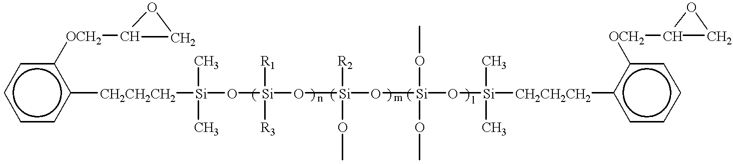

### Production Example 2: Production of the copolymers of silicone compound and polycarbonate resin

Each of the epoxy-modified silicone compounds SE1 to SE7, prepared by Production Examples 1-(I) to 1-(3), was copolymerized with the polycarbonate (PC-3) having hydroxyl group at the terminal, to prepare the copolymers SiPC-1 to SiPC-7 (represented by the general formula, described later).

312.0 g of the polycarbonate (PC-3) having hydroxyl group at the terminal was dissolved in the solution with 4.6 g of the epoxy-modified silicone resin SE1, prepared by the common method (Production Example 1-(1)), dissolved in 400 g of methylene chloride. Then, 1.0 g of triphenylphosphine was added to the above solution, and the reaction process was continued for 5 hours under reflux. The effluent was washed with xylene, and treated under heating and a vacuum to distill off the solvent. This prepared 316.3 g of SiPC-1 (represented by the general formula, described later).

312.0 g of the polycarbonate (PC-3) having hydroxyl group at the terminal was dissolved in the solution with 7.2 g of the epoxy-modified silicone resin SE2, prepared by the common method (Production Example 1-(2)), dissolved in 400 g of methylene chloride. Then, 1.0 g of triphenylphosphine was added to the above solution, and the reaction process was continued for 5 hours under reflux. The effluent was washed with xylene, and treated under heating and a vacuum to distill off the solvent. This prepared 319.1 g of SiPC-2 (represented by the general formula, described later).

312.0 g of the polycarbonate (PC-3) having hydroxyl group at the terminal was dissolved in the solution with 16.4 g of the epoxy-modified silicone resin SE3, prepared by the common method (Production Example 1-(3)), dissolved in 400 g of methylene chloride. Then, 1.0 g of triphenylphosphine was added to the above solution, and the reaction process was continued for 5 hours under reflux. The effluent was washed with xylene, and treated under heating and a vacuum to distill off the solvent. This prepared 327.5 g of SiPC-3 (represented by the general formula, described later).

156.0 g of the polycarbonate (PC-3) having hydroxyl group at the terminal was dissolved in the solution with 25.2 g of the epoxy-modified silicone resin SE4, prepared by the common method (Production Example 1-(4)), dissolved in 300 g of methylene chloride. Then, 1.1 g of triphenylphosphine was added to the above solution, and the reaction process was continued for 5 hours under reflux. The effluent was washed with water, and treated under heating and a vacuum to distill off the solvent. This prepared 180.8 g of SiPC-4 (represented by the general formula, described later).

312.0 g of the polycarbonate (PC-3) having hydroxyl group at the terminal was dissolved in the solution with 16.4 g of the epoxy-modified silicone resin SE5, prepared by the common method (Production Example 1-(5)), dissolved in 400 g of methylene chloride. Then, 1.0 g of triphenylphosphine was added to the above solution, and the reaction process was continued for 5 hours under reflux. The effluent was washed with water, and treated under heating and a vacuum to distill off the solvent. This prepared 327.8 g of SiPC-5 (represented by the general formula, described later).

312.0 g of the polycarbonate (PC-3) having hydroxyl group at the terminal was dissolved in the solution with 16.4 g of the epoxy-modified silicone resin SE6, prepared by the common method (Production Example 1-(6)), dissolved in 400 g of methylene chloride. Then, 1.0 g of triphenylphosphine was added to the above solution, and the reaction process was continued for 5 hours under reflux. The effluent was washed with water, and treated under heating and a vacuum to distill off the solvent. This prepared 328.0 g of SiPC-6 (represented by the general formula, described later).

312.0 g of the polycarbonate (PC-3) having hydroxyl group at the terminal was dissolved in the solution with 16.4 g of the epoxy-modified silicone resin SE7, prepared by the common method (Production Example 1-(7)), dissolved in 400 g of methylene chloride. Then, 1.0 g of triphenylphosphine was added to the above solution, and the reaction process was continued for 5 hours under reflux. The effluent was washed with water, and treated under heating and a vacuum to distill off the solvent. This prepared 327.9 g of SiPC-7 (represented by the general formula, described later).

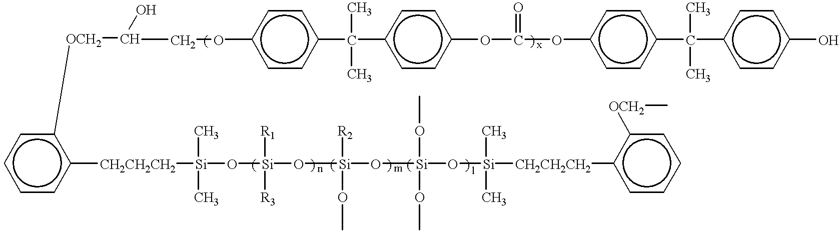

The resin SiPC-1 prepared was heated with sulfuric acid, added with sodium carbonate and calcium carbonate, and heat-treated in an electrical oven. It contained silicon (Si) atom at 0.32%, as determined by the inductively coupled plasma (ICP) emission spectroscopy SiPC-1 had a weight-average molecular weight of 31,400, with the peak shifted to the high-molecular-weight side as a whole from that of the polymer. It was confirmed by the infrared spectral analysis that the epoxy group (absorption wavelength: 918 cm⁻¹) almost disappeared. These observations led to the conclusion that the block copolymer was formed. The SiPC-2 to SiPC-7 resins were analyzed in the same manner. Table 3 gives the silicon (Si) atom contents, weight-average molecular weights and siloxane copolymer contents of the SiPC-1 to SiPC-7 resins.

TABLE 3

| | | Silicon (Si) | Siloxane |
|---|---|---|---|
| | Weight-average | atom content | copolymer |
| | molecular | (% by | content |
| Copolymers | weight | weight) | (% by weight) |
| SiPC-1 (d) | 31,400 | 0.32 | 1.43 |
| SiPC-2 (e) | 31,700 | 0.51 | 2.20 |
| SiPC-3 (f) | 32,600 | 1.12 | 4.9 |
| SiPC-4 (g) | 36,000 | 3.17 | 13.8 |
| SiPC-5 (h) | 32,600 | 0.90 | 4.9 |
| SiPC-6 (i) | 32,600 | 1.32 | 4.9 |
| SiPC-7 (j) | 32,600 | 1.21 | 4.9 |

The silicone types used for the copolymerization are shown in the parentheses.

### Production Example 4: Production of the silicone compound-acrylonitrile-styrene resin copolymers

(1) Production of silicone compound-acrylonitrile-styrene resin copolymer (SiAS-1)

A solution of 2.21 g of triphenylphosphine dissolved in 50 ml of 1,2-dichloroethane was put in a reactor having a stirrer, reflux condenser, drop funnel, and N₂ gas and stock polymer inlet nozzles. Then, a solution of 2.36 g of hexachloroethane dissolved in 50 ml of 1,2-dichloroethane was dropped through the drop funnel in the above solution. On completion of the dropping procedure, the mixed solution was stirred at room temperature for 30 minutes, to which a solution of 152 g acrylonitrile-styrene-copolymer with a carboxyl group at the terminal (AS-2) dissolved in 2000 ml of 1,2-dichloroethane was added. Then, the mixed solution was heated in an oil bath under reflux for 30 minutes. The mixed solution was then left to cool for 10 minutes after the oil bath was taken out of the system, and a solution of 3.0 g of the silicone compound “k” with hydroxyl group at the terminal (Table 2) dissolved in 50 ml of 1,2-dichloroethane was added to the reactor, together with 1.6 ml of triethylamine as the acid-supplementing agent. Then, the solution was heated again in an oil bath under reflux for 20 minutes. The reaction solution was then left to cool to room temperature, and thrown in 81 of methanol for precipitation/purification. The polymer was separated by filtration, washed, and treated for degassing at 1 mmHg and 70° C. to remove the volatiles. This produced 154.6 g of the silicone compound (b)-acrylonitrile-styrene resin copolymer (SiAS-1). SiAS-1 had a weight-average molecular weight of 81,200, with the peak shifted to the high-molecular-weight side as a whole from that of the polymer. It was confirmed by the infrared spectral analysis that the carboxyl group (absorption wavelength: 3550 cm⁻¹) almost disappeared. These observations led to the conclusion that the block copolymer was formed.

(2) Production of silicone compound-acrylonitrile styrene resin copolymer (SiAS-2)

A solution of 2.21 g of triphenylphosphine dissolved in 50 ml of 1,2-dichloroethane was put in a reactor in the same manner as in Production Example 4-(1) . Then, a solution of 2.36 g of hexachloroethane dissolved in 50 ml of 1,2-dichloroethane was dropped through the drop funnel in the above solution. On completion of the dropping procedure, the mixed solution was stirred at room temperature for 30 minutes, to which a solution of 152 g acrylonitrile-styrene copolymer with a carboxyl group at the terminal (AS-2) dissolved in 2000 ml of 1,2-dichloroethane was added. Then, the mixed solution was heated under reflux for 30 minutes. Then, a solution of 30.5 g of the silicone compound “l” with hydroxyl group at the terminal (Table 2) dissolved in 700 ml of 1,2-dichloroethane was added to the reactor, together with 1.6 ml of triethylamine. Then, the solution was heated again under reflux for 25 minutes. The reaction solution was then left to cool to room temperature, and thrown in 121 of methanol for precipitation/purification. The polymer was separated by filtration, washed, and treated for degassing at 1 mmHg and 70° C. to remove the volatiles. This produced 182.0 g of the silicone compound (b) acrylonitrile-styrene resin copolymer (SiAS-2). SiAS-2 had a weight-average molecular weight of 96,000, with the peak shifted to the high-molecular-weight side as a whole from that of the polymer. It was confirmed by the infrared spectral analysis that the carboxyl group (absorption wavelength: 3550 cm⁻¹) almost disappeared. These observations led to the conclusion that the block copolymer was formed.

(3) Production of silicone compound-acrylonitrile styrene resin copolymer (SiAS-3)

A solution of 0.76 g of triphenylphosphine dissolved in 30 ml of 1,2-dichloroethane was put in a reactor in the same manner as in Production Example 4-(l). Then, a solution of 0.81 g of hexachloroethane dissolved in 30 ml of 1,2-dichloroethane was dropped through the drop funnel in the above solution. On completion of the dropping procedure, the mixed solution was stirred at room temperature for 10 minutes, to which a solution of 36.8 g of acrylonitrile-styrene copolymer with a carboxyl group at the terminal (AS-2) dissolved in 600 ml of 1,2-dichloroethane was added. Then, the mixed solution was heated under reflux for 20 minutes. Then, a solution of 23.5 g of the silicone compound “m” with hydroxyl group at the terminal (Table 2) dissolved in 800 ml of 1,2-dichloroethane was added to the reactor, together with 0.6 ml of triethylamine. Then, the solution was heated again under reflux for 25 minutes. The reaction solution was then left to cool to room temperature, and thrown in 31 of methanol for precipitation/purification. The polymer was separated by filtration, washed, and treated for degassing at 1 mmHg and 70° C. to remove the volatiles. This produced 59.9 g of the silicone compound (b)-acrylonitrile-styrene resin copolymer (SiAS-3). SiAS-3 had a weight-average molecular weight of 130,000, with the peak shifted to the high-molecular-weight side as a whole from that of the polymer. It was confirmed by the infrared spectral analysis that the carboxyl group (absorption wavelength: 3550 cm⁻¹) almost disappeared. These observations led to the conclusion that the block copolymer was formed.

(4) Production of silicone compound-acrylonitrile-styrene resin copolymer (SiAS-4)

A solution of 2.21 g of triphenylphosphine dissolved in 50 ml of 1,2-dichloroethane was put in a reactor in the same manner as in Production Example 4-(1). Then, a solution of 2.36 g of hexachloroethane dissolved in 50 ml of 1,2-dichloroethane was dropped through the drop funnel in the above solution. On completion of the dropping procedure, the mixed solution was stirred at room temperature for 30 minutes. A solution of 152 g acrylonitrile-styrene copolymer with a carboxyl group at the terminal (AS-2) dissolved in 2000 ml of 1,2-dichloroethane was then added to the reactor. Then, the mixed solution was heated under reflux for 30 minutes. Then, a solution of 30.5 g of the silicone compound “n” with hydroxyl group at the terminal (Table 2) dissolved in 700 ml of 1,2-dichloroethane was added to the reactor, together with 1.6 ml of triethylamine. Then, the solution was heated again under reflux for 25 minutes. The reaction solution was then left to cool to room temperature, and thrown in 121 of methanol for precipitation/purification. The polymer was separated by filtration, washed, and treated for degassing at 1 mmHg and 700 C to remove the volatiles. This produced 182.0 g of the silicone compound (b)-acrylonitrile-styrene resin copolymer (SiAS-4). SiAS-4 had a weight-average molecular weight of 96,000, with the peak shifted to the high-molecular-weight side as a whole from that of the polymer. It was confirmed by the infrared spectral analysis that the carboxyl group (absorption wavelength: 3550 cm⁻¹) almost disappeared. These observations led to the conclusion that the block copolymer was formed.

Table 4 gives the weight-average molecular weights, silicon (Si) atom contents and siloxane copolymer contents of SiAS-1 to SiAS-4.

TABLE 4

| | | Silicon (Si) | Siloxane |
|---|---|---|---|
| | Weight-average | atom content | copolymer |
| | molecular | (% by | content |
| Copolymers | weight | weight) | (% by weight) |
| SiAS-1 (k) | 81,200 | 0.25 | 1.47 |
| SiAS-2 (l) | 96,000 | 2.7 | 16.4 |
| SiAS-3 (m) | 130,000 | 6.5 | 38.4 |
| SiAS-4 (n) | 96,000 | 6 | 16.4 |

The silicone types used for the copolymerization are shown in the parentheses.

The thermoplastic resins, dried at 100° C. for 5 hours, were analyzed for melting viscosity at 240 or 260° C. and a shear rate of 300 sec⁻¹ by a flow tester (Shimadzu Corporation, Shimadzu Flow Tester CFT500D), and for surface tension at 20° C. and 50% RH by a contact angle analyzer (Kyowa Kagaku, CA-A). The results are given in Tables 5 and 6.

TABLE 5

| | *Melting | **Surface | |
|---|---|---|---|
| | viscosity | tension | ***Oxygen |
| | (Pa · s) | (dyn/cm) | index |
| PC | 800 | 44 | 25 |
| AS | 180 | 36 | 18 |
| SiPC-1 (d) | 160 | 33 | 29 |
| SiPC-2 (e) | 160 | 33 | 32 |
| SiPC-3 (f) | 150 | 32 | 34 |
| SiPC-4 (g) | 140 | 31 | 35 |
| SiPC-5 (h) | 150 | 32 | 28 |
| SiPC-6 (i) | 150 | 32 | 24 |
| SiPC-7 (j) | 150 | 32 | 25 |

The silicone types used for the copolymerization are shown in the parentheses.
*Melting viscosity was measured at 260° C. and a shear rate of 300 sec⁻¹
**Surface tension was measured at 20° C. and 50% RH
***Oxygen index was measured for the injection-molded, flame-retardancy evaluation specimens (125 by 6 by 3.2 mm), in accordance with JIS K-7201.

TABLE 6

| | *Melting | **Surface | |
|---|---|---|---|
| | viscosity | tension | ***Oxygen |
| | (Pa · s) | (dyn/cm) | index |
| AS | 180 | 36 | 18 |
| SiAS-1 (k) | 150 | 35 | 21 |
| SiAS-2 (l) | 140 | 34 | 25 |
| SiAS-3 (m) | 120 | 33 | 26 |
| SiAS-4 (n) | 110 | 33 | 20 |

The silicone types used for the copolymerization are shown in the parentheses.
*Melting viscosity was measured at 240° C. and a shear rate of 300 sec⁻¹
**Surface tension was measured at 20° C. and 50% RH
***Oxygen index was measured for the injection-molded, flame-retardancy evaluation specimens (125 by 6 by 3.2 mm), in accordance with JIS K-7201.

The resin compositions comprising the above materials were analyzed for flame-retardancy. The results are given in Tables 7 to 15, wherein the siloxane content means the content (% by weight) of the siloxane contained in each composition, and siloxane content relative to the copolymer quantity means the content (% by weight) of the siloxane contained in each copolymer, based on the whole composition, and oxygen index is the one measured for the injection-molded, flame-retardancy evaluation specimen (125 by 6 by 3.2 mm) in accordance with JIS K-7201.

Each of the compositions prepared by Examples, Reference Examples 1 to 23 and Comparative Examples 1 to 16 was molten and kneaded by a 37 mm-diameter biaxial extruder (Kobe Steel, Ltd., KTX-37) at a cylinder temperature of 260° C. into the pellets.

These pellets were dried at 100° C. for 5 hours, and molded by an injection molder (Japan Steel Works, Ltd., J100-E-C5) at 260° C. and an injection pressure of 600 Kg/cm², to prepare the specimen (125 by 6 by 3.2 mm) for evaluation of flame-retardancy.

The injection-molded specimen (125 by 6 by 3.2 mm) for evaluation of flame-retardancy was tested to determine its oxygen index, in accordance with JIS K-7201.

Each of the compositions prepared by Examples 24 to 38 and Comparative Examples 17 and 18 was molten and kneaded by a 37 mm-diameter biaxial extruder (Kobe Steel, Ltd., KTX-37) at a cylinder temperature of 240° C. into the pellets.

These pellets were dried at 80° C. for 5 hours, and molded by an injection molder (Japan Steel Works, Ltd., J100-E-C5) at 240° C. and an injection pressure of 600 Kg/cm², to prepare the specimen (125 by 6 by 3.2 mm) for evaluation of flame-retardancy.

The injection-molded specimen (125 by 6 by 3.2 mm) for evaluation of flame-retardancy was tested to determine its oxygen index, in accordance with JIS K-7201. The results are given in Tables 16 and 17.

TABLE 7

| | Examples | | | | |
|---|---|---|---|---|---|
| | 1 | 2 | 3 | 4 | 5 |
| PC | 0.7 | 0.0 | 17.2 | 42.7 | 17.2 |
| AS | 99.3 | 100.0 | 82.8 | 57.3 | 82.8 |
| SiPC-1 (d) | 99.9 | — | — | — | — |
| SiPC-2 (e) | — | 102.2 | — | — | — |
| SiPC-3 (f) | — | — | 69.0 | — | — |
| SiPC-4 (g) | — | — | — | 16.9 | — |
| SiPC-5 (h) | — | — | — | — | 69.0 |
| Siloxane content* | 0.7 | 1 | 2 | 2 | 2 |
| (% by weight) | | | | | |
| Siloxane content | 0.7 | 1 | 2 | 2 | 2 |
| relative to the | | | | | |
| copolymer quantity** | | | | | |
| (% by weight) | | | | | |
| Flame-retardancy | 25 | 27 | 30 | 27 | 23 |
| (oxygen index) | | | | | |

The silicone types used for the copolymerization are shown in the parentheses.

Each of the compositions prepared by Examples 1 to 5 is characterized by the total PC:total AS ratio of 50:50 by weight.

TABLE 8

| | Examples | | | | | |
|---|---|---|---|---|---|---|
| | 6 | 7 | 8 | 9 | 10 | 11 |
| PC | 0.0 | 0.0 | 8.5 | 8.5 | 37.7 | 50 |
| AS | 100.0 | 100.0 | 91.5 | 91.5 | 62.3 | 50 |
| SiPC-1 (d) | 101.3 | 101.3 | — | — | — | — |
| SiPC-2 (e) | — | — | 84.9 | 84.9 | — | — |
| SiPC-3 (f) | — | — | — | — | 26.0 | — |
| Silicone “a” | 2.7 | — | 1.9 | — | 1.3 | 2.0 |
| Silicone “b” | — | 2.7 | — | 1.9 | — | — |
| Siloxane content* | 2 | 2 | 2 | 2 | 2 | 2 |
| (% by weight) | | | | | | |
| Siloxane content | 0.7 | 0.7 | 1 | 1 | 1 | 0 |
| relative to the | | | | | | |
| copolymer quantity** | | | | | | |
| (% by weight) | | | | | | |
| Flame-retardancy | 28 | 26 | 30 | 28 | 33 | 23 |
| (oxygen index) | | | | | | |

The silicone types used for the copolymerization are shown in the parentheses.

Each of the compositions prepared by Examples 6 to 11 is characterized by the total PC:total AS ratio of 50:50 by weight.

TABLE 9

| | Examples | | Reference Examples | | | |
|---|---|---|---|---|---|---|
| | 12 | 13 | 14 | 15 | 16a | 16b |
| PC | 46.6 | 46.6 | 37.7 | 37.7 | 37.7 | 37.7 |
| AS | 53.4 | 53.4 | 62.3 | 62.3 | 62.3 | 62.3 |
| SiPC-4 (g) | 7.9 | 7.9 | — | — | — | — |
| SiPC-5 (h) | — | — | 26.0 | 26.0 | — | — |
| SiPC-6 (i) | — | — | — | — | 26.0 | 26.0 |
| Silicone “a” | 1.1 | — | 1.3 | — | 1.3 | — |
| Silicone “b” | — | 1.1 | — | 1.3 | — | 1.3 |
| Siloxane content* | 2 | 2 | 2 | 2 | 2 | 2 |
| (% by weight) | | | | | | |
| Siloxane content | 1 | 1 | 1 | 1 | 1 | 1 |
| relative to the | | | | | | |
| copolymer quantity** | | | | | | |
| (% by weight) | | | | | | |
| Flame-retardancy | 30 | 28 | 26 | 24 | 22 | 21 |
| (oxygen index) | | | | | | |

The silicone types used for the copolymerization are shown in the parentheses.

Each of the compositions prepared by Examples and Reference Examples is characterized by the total PC total AS ratio of 50:50 by weight.

TABLE 10

| | Examples | | | |
|---|---|---|---|---|
| | 19 | 20 | 22 | 23 |
| PC | 12.7 | 0.1 | 62.6 | 57.1 |
| AS | 87.3 | 99.9 | 37.4 | 42.9 |
| SiPC-3 (f) | 26.0 | 45.0 | 26.0 | 45.1 |
| Silicone “a” | 1.3 | 2.2 | 1.3 | 2.2 |
| Siloxane content* | 2 | 3 | 2 | 3 |
| (% by weight) | | | | |
| Siloxane content | 1 | 1.5 | 1 | 1.5 |
| relative to the | | | | |
| copolymer quantity** | | | | |
| (% by weight) | | | | |
| Flame-retardancy | 25 | 27 | 35 | 36 |
| (oxygen index) | | | | |

The silicone types used for the copolymerization are shown in the parentheses.

Each of the compositions prepared by Examples 19 to 20 is characterized by the total PC:total AS ratio of 30:70 by weight, and each of the compositions prepared by Examples 22 and 23 is characterized by the total PC:total AS ratio of 70:30 by weight.

TABLE 11

| | Examples | | | | | | | |
|---|---|---|---|---|---|---|---|---|
| | 24 | 25 | 26 | 27 | 28 | 29 | 30 | 31 |
| AS | 75.6 | 87.6 | 87.6 | 67.9 | 89.6 | 94.7 | 94.7 | 86.3 |
| SiAS-2(l) | 24.4 | 12.4 | 12.4 | 32.1 | — | — | — | — |
| SiAS-3(m) | — | — | — | — | 10.4 | 5.3 | 5.3 | 13.7 |
| Silicone “a” | — | 2.0 | — | 5.3 | — | 2.0 | — | 5.3 |
| Silicone “b” | — | — | 2.0 | — | — | — | 2.0 | — |
| Siloxane | 4 | 4 | 4 | 10 | 4 | 4 | 4 | 10 |
| content (% by | | | | | | | | |
| weight) | | | | | | | | |
| Siloxane | 4 | 2 | 2 | 5 | 4 | 2 | 2 | 5 |
| content | | | | | | | | |
| relative to the | | | | | | | | |
| copolymer | | | | | | | | |
| quantity (% by | | | | | | | | |
| weight) | | | | | | | | |
| Flame- | 23 | 25 | 24 | 27 | 22 | 24 | 23 | 25 |
| retardancy | | | | | | | | |
| (oxygen index) | | | | | | | | |

The silicone types used for the copolymerization are shown in the parentheses.

Each of the compositions prepared by Examples 24 to 31 is totally composed of total AS except the siloxane content (% by weight).

TABLE 12

| | Examples | | | | | | |
|---|---|---|---|---|---|---|---|
| | 32 | 33 | 34 | 35 | 36 | 37 | 38 |
| AS | 16.7 | 14.1 | 16.7 | 16.7 | 87.8 | 87.8 | 69.5 |
| SiAS-1(k) | 83.3 | 85.9 | 83.3 | 83.3 | — | — | — |
| SiAS-4(n) | — | — | — | — | 12.2 | 12.2 | 30.5 |
| Silicone “a” | — | 3.1 | — | 9.8 | 2.0 | — | 5.3 |
| Silicone “b” | — | — | 3.1 | — | — | 2.0 | — |
| Siloxane | 1 | 4 | 4 | 10 | 4 | 4 | 10 |
| content (% by | | | | | | | |
| weight) | | | | | | | |
| Siloxane | 1 | 1 | 1 | 1 | 2 | 2 | 5 |
| content | | | | | | | |
| relative to the | | | | | | | |
| copolymer | | | | | | | |
| quantity (% by | | | | | | | |
| weight) | | | | | | | |
| Flame- | 21 | 22 | 21 | 23 | 21 | 20 | 21 |
| retardancy | | | | | | | |
| (oxygen index) | | | | | | | |

The silicone types used for the copolymerization are shown in the parentheses.

Each of the compositions prepared by Examples 32 to 38 is totally composed of total AS except the siloxane content (% by weight).

TABLE 13

| | Comparative Examples | | | | | | | | | | |
|---|---|---|---|---|---|---|---|---|---|---|---|
| | 1 | 2 | 3 | 4 | 5 | 6 | 7 | 8 | 9 | 10 | 11 |
| PC | 30 | 0.0 | 0.0 | 12.7 | 12.7 | 50 | 17.2 | 17.2 | 37.7 | 37.7 | 50 |
| AS | 70 | 100.0 | 100.0 | 87.3 | 87.3 | 50 | 82.8 | 82.8 | 62.3 | 62.3 | 50 |
| SiPC-6(i) | — | 45.1 | — | 26.0 | — | — | 69.0 | — | 26.0 | — | — |
| SiPC-7(j) | — | — | 45.1 | — | 26.0 | — | — | 69.0 | — | 26.0 | — |
| Silicone | — | — | — | 1.3 | 1.3 | — | — | — | 1.3 | 1.3 | 2.0 |
| “c” | | | | | | | | | | | |
| Siloxane | — | 1.5 | 1.5 | 2 | 2 | — | 2 | 2 | 2 | 2 | 2 |
| content * | | | | | | | | | | | |
| (% by | | | | | | | | | | | |
| weight) | | | | | | | | | | | |
| Siloxane | — | 1.5 | 1.5 | 1 | 1 | — | 2 | 2 | 1 | 1 | 0 |
| content | | | | | | | | | | | |
| relative to | | | | | | | | | | | |
| the | | | | | | | | | | | |
| copolymer | | | | | | | | | | | |
| quantity | | | | | | | | | | | |
| ** (% by | | | | | | | | | | | |
| weight) | | | | | | | | | | | |
| Flame- | 18 | 18 | 18 | 18 | 18 | 18 | 19 | 19 | 18 | 19 | 18 |
| retardancy | | | | | | | | | | | |
| (oxygen | | | | | | | | | | | |
| index) | | | | | | | | | | | |

The silicone types used for the copolymerization are shown in the parentheses.

Each of the compositions prepared by Comparative Examples 1 to 5 is characterized by the total PC:total AS ratio of 30:70 by weight, and each of the compositions prepared by Comparative Examples 6 to 11 is characterized by the total PC:total AS ratio of 50:50 by weight.

TABLE 14

| | Comparative Examples | | | | |
|---|---|---|---|---|---|
| | 12 | 13 | 14 | 15 | 16 |
| PC | 70 | 50.3 | 50.3 | 62.6 | 62.6 |
| AS | 30 | 49.7 | 49.7 | 37.4 | 37.4 |
| SiPC-6(i) | — | 69.0 | — | 26.0 | — |
| SiPC-7(i) | — | — | 69.0 | — | 26.0 |
| Silicone “c” | — | — | — | 1.3 | 1.3 |
| Siloxane | — | 2 | 2 | 2 | 2 |
| content * (% | | | | | |
| by weight) | | | | | |
| Siloxane | — | 2 | 2 | 1 | 1 |
| content | | | | | |
| relative to the | | | | | |
| copolymer | | | | | |
| quantity ** (% | | | | | |
| by weight) | | | | | |
| Flame- | 18 | 19 | 18 | 19 | 18 |
| retardancy | | | | | |
| (oxygen index) | | | | | |

The silicone types used for the copolymerization are shown in the parentheses.

Each of the compositions prepared by Comparative Examples 12 to 16 is characterized by the total PC:total AS ratio of 70:30 by weight.

TABLE 15

Reference
Examples

| | 17 | 18 |
|---|---|---|
| AS | 87.8 | 69.5 |
| SiAS-4(n) | 12.2 | 30.5 |
| Silicone “c” | 2.0 | 5.3 |
| Siloxane | 4 | 10 |
| content (% by | | |
| weight) | | |
| Siloxane | 2 | 5 |
| content | | |
| relative to the | | |
| copolymer | | |
| quantity (% by | | |
| weight) | | |
| Flame- | 19 | 18 |
| retardancy | | |
| (oxygen index) | | |

The silicone types used for the copolymerization are shown in the parentheses.

Each of the compositions prepared by Reference Examples 17 and 18 is totally composed of total AS except the siloxane content (% by weight).

Each of the resin compositions prepared by Examples 1 to 5, i.e., the acrylonitrile-styrene and polycarbonate resin compositions (Comparative Example 1, 6 or 12) which is incorporated with a silicone compound-polycarbonate copolymer, shows much higher flame-retardant effect than the composition free of the silicone compound-polycarbonate copolymer. Moreover, the composition comprising a silicone compound and silicone compound-polycarbonate copolymer (prepared by Examples 6 to 15, 19, 20, 22 or 23) shows very high flame-retardant effect.

When the composition comprises a silicone compound and silicone compound-carbonate copolymer (Reference Examples 16a and 16b), relatively high flame-retardant effect is obtained when the silicone compound to be copolymerized has a structure of polyalkyl siloxane compound, but still higher flame-retardant effect is obtained when it has a main chain of a branched structure and aromatic residue as the organic functional group, as shown by Examples 6 to 15. Therefore, the latter silicone compound structure is more preferable.

Each of the acrylonitrile-styrene and polycarbonate resin compositions, when incorporated with a polyalkyl siloxane-polycarbonate copolymer (SiPC-6) or further with a silicone compound having a structure other than that for the present invention (silicone “c”), i.e., the composition prepared by Comparative Example 2, 4, 7, 9, 13 or 15, shows no improvement in oxygen index and hence no flame-retardant effect.

Each of the resin compositions comprising a copolymer having a low content of aromatic residue as the organic functional group or further with a silicone compound having a structure other than that for the present invention, i.e., the composition prepared by Comparative Example 3, 5, 8, 10, 14 or 16, also shows no improvement in oxygen index and hence no flame-retardant effect.

It is found that the silicone to be copolymerized makes the resin composition more flame-retardant, when it has a molecular weight of 300 or more, preferably 500 or more, still more preferably 1000 or more, as shown by Examples 1, 6 and 7 (silicone “d” having a molecular weight of 450 was used), Examples 2, 8 and 9 (silicone “e” having a molecular weight of 700 was used), and Examples 3, 4 and 10 to 13 (silicone “f” having a molecular weight of 1600 or silicone “g” having a molecular weight of 5000 was used).

It is also found that the silicone to be copolymerized makes the resin composition still more flame-retardant, when it has a branched unit content α(=c+d) more than 0.2, preferably more than 0.4, as shown by Examples 1 to 4 and 6 to 13 (c+d: more than 0.5) and Examples 5, 14 and 15 (c+d: 0.29). Therefore, use of such a silicone compound is more preferable.

It is also found, when the results of Examples 5, 14 and 16 (SiPC-5, i.e., silicone “h” was used) are compared with those of Comparative Examples 8 and 15 (SiPC-7, i.e., silicone “j” was used), the silicone to be copolymerized makes the resin composition more flame-retardant, when it contains an aromatic residue as the organic functional group at 30% or more. Therefore, use of such a silicone compound is more preferable.

Each of the acrylonitrile-styrene and acrylonitrile styrene-silicone copolymer compositions (Examples 27 and 31) shows very high flame-retardant effect, when incorporated with a silicone compound-acrylonitrile styrene copolymer and silicone compound (Examples 28 to 30, and 32 to 34).

Each of the polyalkyl siloxane-acrylonitrile-styrene copolymers incorporated with a silicone compound having a structure other than that for the present invention (Comparative Examples 17 and 18) also shows no improvement in oxygen index and hence no flame-retardant effect.

When the composition comprises a silicone compound and silicone compound-acrylonitrile-styrene copolymer, relatively high flame-retardant effect is obtained when the silicone compound to be copolymerized has a structure of polyalkyl siloxane compound, but still higher flame-retardant effect is obtained when it has a main chain of a branched structure and aromatic residue as the organic functional group, as shown in Tables 11 and 12. Therefore, the latter silicone compound structure is more preferable.

As described above, the resin composition incorporated with the copolymer of the present invention shows much improved flame-retardancy. The improvement effect is more noted than the mixture of a silicone compound.

(Measurement of silicone distribution in the formed article)

The formed article of the composition prepared by Example 4 was measured for the distribution of the silicone derived from SiPC-4.

The formed article (125 by 13 by 3.2 mm) was sliced at 10 mm from the side, and the elementary Si analysis was done by the EDS analysis (energy dispersion type X-ray elementary analysis) on the sliced section to measure the Si distribution in the depth direction. It is confirmed that the Si element concentration is very high in the surface area and low inside.

The elementary Si analysis was done by the EDS analysis for the formed article surface at several points, to find that the Si is distributed fairly uniformly.

Next, the same analytical procedure was used to measure the distribution of the silicone derived from the dimethyl siloxane for the formed article of the composition prepared by Example 6.

For the distribution in the depth direction, it is confirmed that the Si element concentration is very high in the surface area and low inside.

The elementary Si analysis by the EDS analysis for the formed article surface at several points showed that the Si was distributed unevenly, confirming uneven distribution of silicone.

(Particle size of the dispersed silicone on the formed article surface)

Particle size of the dispersed Si elements on the formed article surface was measured by the EDS analysis.

TABLE 16

| | Particle size (μm) |
|---|---|
| Example 3 | 1-3 |
| Example 11 | 8-21 |
| Comparative Example 11 | 100-150 |
| Comparative Example 7 | 80-120 |

As described above, the copolymer of the present invention, comprising a silicone compound of specific structure as the copolymer component, has unprecedentedly high flame-retardancy, and makes a resin, e.g., polycarbonate-based resin, highly flame-retardant when incorporated therein. Moreover, it can keep high flame-retardancy even when used in combination with a resin of low flame-retardancy, and can realize the resin composition of high flame-retardancy, low cost and good formability. The resin composition shows high flame retardancy, even when recycled from the formed article. It may contain a halogen-based flame-retardant only to a limited extent, causing no emission of toxic gases containing the retardant-derived halogen when it burns, and hence environmentally preferable. It may contain a phosphorus-based flame-retardant only to a limited extent, and hence is excellent in resistance to moisture and heat.

The entire disclosure of Japanese Patent applications no. 2000-084482, no. 2000-084484 including specification, claims, drawings and summary are incorporated herein by reference in its entirely:

What is claimed is:

1. A polysiloxane-containing copolymer obtained by copolymerizing of a silicone compound and a polycarbnate based resin,
said silicone compound having an aromatic residue and an organopolysiloxane shown by the general formula (I) as a basic backbone:
(R¹₃SiO_{0.5})ₐ(R²₂SiO)_{b}(R³SiO_{1.5})_{c}(SiO₂)_{d} (I)
wherein R¹, R² and R³ are each an aromatic residue or hydrocarbon group having a carbon atom number of 1 to 6, which may be the same or different; and “a”, “b”, “c” and “d” satisfy a relationship (a+b+c+d)=1, and said aromatic residue accounts for 30 to 95% of the total functional groups said silicone compound has, and a relationship 0<c+d holds in the general formula (I).

2. The polysiloxane-containing copolymer according to claim 1, wherein a relationship 0.2<c+d<0.95 holds in the general formula (I).

3. The polysiloxane-containing copolymer according to claim 2, wherein a relationship 0.5<c+d<0.95 holds in the general formula (I).

4. The polysiloxane-containing copolymer according to one of claims 1, wherein said silicone compound has a weight-average molecular weight of 300 to 100,000.

5. The polysiloxane-containing copolymer according to one of claims 1, wherein said copolymer is obtained by copolymerizing of 0.5 to 80% by weight of said silicone compound and 20 to 99.5% by weight of said polycarbonate-based resin.

6. A polysiloxane-containing copolymer obtained by copolymerizing of a silicone compound and a liquid-crystal polyester,
said silicone compound having an aromatic residue and an organopolysiloxane shown by the general formula (I) as a basic backbone:
(R¹₃SiO_{0.5})ₐ(R²₂SiO)_{b}(R³SiO_{1.5})_{c}(SiO₂)_{d} (I)
wherein R¹, R² and R³ are each an aromatic residue or hydrocarbon group having a carbon atom number of 1 to 6, which may be the same or different; and “a”, “b”, “c” and “d” satisfy a relationship (a+b+c+d)=1 and c+d>0.

7. The polysiloxane-containing copolymer according to claim 6, wherein said copolymer is obtained by copolymerizing of 0.5 to 80% by weight of said silicone compound and 20 to 99.5% by weight of said liquid-crystal polyester.

8. A polysiloxane-containing copolymer obtained by copolymerizing of a silicone compound and a polystyrene based resin,
said silicone compound having an aromatic residue and an organopolysiloxane shown by the general formula (I) as a basic backbone:
(R¹₃SiO_{0.5})ₐ(R²₂SiO)_{b}(R³SiO_{1.5})_{c}(SiO₂)_{d} (I)
wherein R¹, R² and R³ are each an aromatic residue or hydrocarbon group having a carbon atom number of 1 to 6, which may be the same or different; and “a”, “b”, “c” and “d” satisfy a relationship (a+b+c+d)=1 and c+d>0.

9. The polysiloxane-containing copolymer according to claim 8, wherein said copolymer is obtained by copolymerizing of 0.5 to 80% by weight of said silicone compound and 20 to 99.5% by weight of said polystyrene based resin.

10. A polysiloxane-containing copolymer comprising:
structural unit (A) derived from a silicone compound having an organopolysiloxane shown by the general formula (I) as a basic backbone:
(R¹₃SiO_{0.5})ₐ(R²₂SiO)_{b}(R³SiO_{1.5})_{c}(SiO₂)_{d} (I)
wherein, R¹, R² and R³ are each an aromatic residue or hydrocarbon group having a carbon atom number of 1 to 6, which may be the same or different; and “a”, “b”, “c” and “d” satisfy a relationship (a+b+c+d)=1, and an aromatic residue; and
structural unit (B) containing an aromatic residue in a main chain backbone or side chain,
wherein said aromatic residue accounts for 30 to 95% of the total functional groups said silicone compound has, and the relationship 0<c+d holds in the general formula (1).

11. The polysiloxane-containing copolymer according to claim 10, characterized by comprising 0.5 to 80% by weight of said structural unit (A) and 20 to 99.5% by weight of said structural unit (B).

12. A flame-retardant resin composition comprising: 0.5 to 80% by weight of said polysiloxane-containing copolymer according to claim 1; and
20 to 99.5% by weight of one or more resins selected from the group consisting of polycarbonate-based resins, liquid-crystal polyesters and polystyrene-based resins.

13. A flame-retardant resin composition comprising:
0.5 to 80% by weight of said polysiloxane-containing copolymer according to claim 6; and
20 to 99.5% by weight of one or more resins selected from the group consisting of polycarbonate-based resins, liquid-crystal polyesters and polystyrene-based resins.

14. A flame-retardant resin composition comprising: 0.5 to 80% by weight of said polysiloxane-containing copolymer according to claim 8; and
20 to 99.5% by weight of one or more resins selected from the group consisting of polycarbonate-based resins, liquid-crystal polyesters and polystyrene-based resins.

15. A flame-retardant resin composition comprising: 0.5 to 80% by weight of said polysiloxane-containing copolymer according to claim 10; and
20 to 99.5% by weight of one or more resins selected from the group consisting of polycarbonate-based resins, liquid-crystal polyesters and polystyrene-based resins.
